(19) United States
(12) Patent Application Publication
(10) Pub. No.: US 2024/0236750 A1
(43) Pub. Date: Jul. 11, 2024

(54) METHOD AND APPARATUS FOR MEASUREMENT INTERVAL ENHANCEMENT, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Rongyi HU, Dongguan (CN); Jinyu ZHANG, Dongguan (CN)

(73) Assignee: GUANGDONG OPPO MOBILE TELECOMMUNICATIONS CORP., LTD., Dongguan (CN)

(21) Appl. No.: 18/613,022

(22) Filed: Mar. 21, 2024

Related U.S. Application Data
(63) Continuation of application No. PCT/CN2021/119988, filed on Sep. 23, 2021.

(51) Int. Cl. H04W 24/10; H04W 72/0457; H04W 76/15; H04W 76/20

(52) U.S. Cl. CPC H04W 24/10; H04W 72/0457; H04W 76/15; H04W 76/20

(57) ABSTRACT

Provided are a method and apparatus for measurement interval enhancement, a terminal device, and a network device. The method includes that: a terminal device receives configuration information of coexisting measurement intervals, the coexisting measurement intervals including a plurality of measurement intervals and at least some of the measurement intervals among the plurality of measurement intervals being preconfigured measurement intervals, wherein the preconfigured measurement intervals can be activated or deactivated.

### CROSS-REFERENCE TO RELATED APPLICATION

This is a continuation application of International Patent Application No. PCT/CN2021/119988, filed on Sep. 23, 2021, entitled “METHOD AND APPARATUS FOR MEASUREMENT INTERVAL ENHANCEMENT, TERMINAL DEVICE, AND NETWORK DEVICE”, the disclosure of which is hereby incorporated by reference in its entirety.

### BACKGROUND

In order that a terminal device realizes mobility switching better, a network may configure a specific time window for the terminal device so that the terminal device performs measurement in the specific time window and performs mobility switching based on a measurement result. The specific time window is referred to as a measurement gap (MG), or gap for short. At present, when a network configures a measurement gap for a terminal device, only one measurement gap can be configured in a period. The duration of one measurement gap is limited, resulting in low measurement efficiency.

### SUMMARY

Embodiments of the disclosure relates to the technical field of mobile communications, and in particular to a method and apparatus for measurement gap enhancement, a terminal device and a network device.

Embodiments of the disclosure provide a method and apparatus for measurement gap enhancement, a terminal device, a network device, a chip, a computer-readable storage medium, a computer program product, and a computer program.

The method for measurement gap enhancement according to embodiments of the disclosure includes: receiving, by a terminal device, configuration information of concurrent gaps, wherein the concurrent gaps include multiple measurement gaps, at least part of the multiple measurement gaps are preconfigured measurement gaps, and the preconfigured measurement gaps are capable of being activated or deactivated.

The terminal device according to the embodiments of the disclosure includes a processor and a memory. The memory is configured to store a computer program, and the processor is configured to call and run the computer program stored in the memory to perform operation of: receiving configuration information of concurrent gaps, wherein the concurrent gaps include multiple measurement gaps, at least part of the multiple measurement gaps are preconfigured measurement gaps, and the preconfigured measurement gaps are capable of being activated or deactivated.

The network device according to the embodiments of the disclosure includes a processor and a memory. The memory is configured to store a computer program, and the processor is configured to call and run the computer program stored in the memory to perform operation of: sending configuration information of concurrent gaps, wherein the concurrent gaps include multiple measurement gaps, at least part of the multiple measurement gaps are preconfigured measurement gaps, and the preconfigured measurement gaps are capable of being activated or deactivated.

By means of the above technical solution, a scheme of measurement gap enhancement is provided. A network device configures concurrent gaps for a terminal device. The concurrent gaps include multiple measurement gaps. At least part of the multiple measurement gaps are preconfigured measurement gaps. The preconfigured measurement gaps are capable of being activated or deactivated.

### BRIEF DESCRIPTION OF THE DRAWINGS

The drawings described herein serve for further understanding of the disclosure, and constitute a part of the disclosure. Exemplary embodiments of the disclosure and description thereof are used to explain the disclosure and do not form inappropriate limitation of the disclosure. In the drawings:

FIG. 1 illustrates a schematic diagram of a communication system architecture according to embodiments of the disclosure.

FIG. 2 illustrates a schematic flowchart of a method for measurement gap enhancement according to embodiments of the disclosure.

FIG. 3 illustrates a first schematic diagram of structural composition of an apparatus for measurement gap enhancement according to embodiments of the disclosure.

FIG. 4 illustrates a second schematic diagram of structural composition of an apparatus for measurement gap enhancement according to embodiments of the disclosure.

FIG. 5 illustrates a schematic structural diagram of a communication device according to embodiments of the disclosure.

FIG. 6 illustrates a schematic structural diagram of a chip according to embodiments of the disclosure.

FIG. 7 illustrates a schematic block diagram of a communication system according to embodiments of the disclosure.

### DETAILED DESCRIPTION

Technical solutions of the embodiments of the disclosure will be described below in combination with the drawings of the embodiments of the disclosure. Apparently, the described embodiments are some rather than all embodiments of the disclosure. All other embodiments obtained by those skilled in the art based on the embodiments of the disclosure without paying any inventive effort shall fall within the scope of protection of the disclosure.

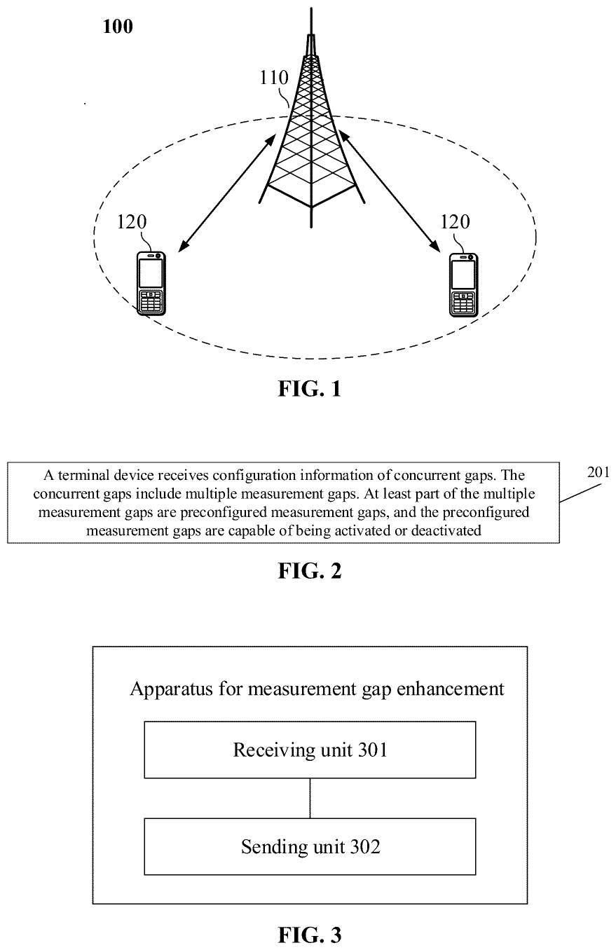

FIG. 1 illustrates a schematic diagram of an application scenario according to embodiments of the disclosure.

As illustrated in FIG. 1, a communication system 100 may include a terminal device 110 and a network device 120. The network device 120 may communicate with the terminal device 110 through an air interface. Multi-service transmission is supported between the terminal device 110 and the network device 120.

It is to be understood that the communication system 100 is provided here to describe the embodiments of the disclosure in an exemplary way, but the embodiments of the disclosure are not limited thereto. That is to say, the technical solutions of the embodiments of the disclosure may be applied to various communication systems, for example, a long term evolution (LTE) system, an LTE time division duplex (TDD) system, a universal mobile telecommunication system (UMTS), an Internet of Things (IoT) system, a narrow band Internet of Things (NB-IoT) system, an enhanced machine-type communications (eMTC) system, a 5th-generation communication system (or referred to as new radio (NR) communication system), a future communication system.

In the communication system 100 as illustrated in FIG. 1, the network device 120 may be an access network device communicating with the terminal device 110. The access network device can provide communication coverage for a specific geographical area, and can communicate with the terminal device 110 (e.g., user equipment (UE)) within the coverage.

The network device 120 may be an evolutional Node B (eNB or eNodeB) in an LTE system, or a next generation radio access network (NG RAN) device, or a gNB in an NR system, or a radio controller in a cloud radio access network (CRAN). Alternatively, the network device 120 may be a relay station, an access point, a vehicle-mounted device, a wearable device, a hub, a switch, a network bridge, a router, a network device in a future evolved public land mobile network (PLMN) or the like.

The terminal device 110 may be any terminal device, including but not limited to a terminal device in wired or wireless connection with the network device 120 or another terminal device.

For example, the terminal device 110 may refer to an access terminal, user equipment (UE), a subscriber unit, a subscriber station, a mobile station, a mobile platform, a remote station, a remote terminal, a mobile device, a user terminal, a terminal, a wireless communication device, a subscriber agent or a user device. The access terminal may be a cellular phone, a cordless phone, a session initiation protocol (SIP) phone, an IoT device, a satellite hand-held terminal, a wireless local loop (WLL) station, a personal digital assistant (PDA), a hand-held device with a wireless communication function, a computing device or another processing device connected to a radio modem, vehicle-mounted device, wearable device, a terminal device in a 5G network, a terminal device in a future evolved network or the like.

The terminal device 100 may be used in device to device (D2D) communication.

The wireless communication system 100 may further include a core network device 130 in communication with a base station. The core network device 130 may be a 5G core (5GC) device, for example, an access and mobility management function (AMF), for another example, an authentication server function (AUSF), for another example, a user plane function (UPF), for another example, a session management function (SMF). Optionally, the core network device 130 may also be an evolved packet core (EPC) device in an LTE network, for example, a session management function+core packet gateway (SMF+PGW-C) device. It is to be understood that the SMF+PGW-C can realize the functions of both an SMF and a PGW-C. During evolution of the network, the core network device may also have other names, or the function of the core network may be divided to form new network entities, which are not limited in the embodiments of the disclosure.

Various functional units of the communication system 100 may also establish a connection with one another through a next generation (NG) interface so as to realize communication.

For example, the terminal device establishes an air interface connection with an access network device through an NR interface, so as to transmit user plane data and a control plane signaling. The terminal device may establish a control plane signaling connection with the AMF through an NG interface 1 (N1 for short). The access network device (for example, a gNB) may establish a user plane data connection with the UPF through an NG interface 3 (N3 for short). The access network device may establish a control plane signaling connection with the AMF through an NG interface 2 (N2 for short). The UPF may establish a control plane signaling connection with the SMF through an NG interface 4 (N4 for short). The UPF may interact user plane data with a data network through a NG interface 6 (N6 for short). The AMF may establish a control plane signaling connection with the SMF through an NG interface 11 (N11 for short). The SMF may establish a control plane signaling connection through an NG interface 7 (N7 for short).

FIG. 1 exemplarily illustrates a base station, a core network device and two terminal devices. Optionally, the wireless communication system 100 may include multiple base stations, and there may be another number of terminal devices within the coverage of each base station, which is not limited in the embodiments of the disclosure.

It is to be noted that FIG. 1 merely illustrate a system to which the disclosure is applicable in an exemplary way. Of course, the method illustrated in the embodiments of the disclosure may also be applicable to other systems. In additional, the terms “system” and “network” herein are often used exchangeably. The term “and/or” herein merely describes a relation between associated objects, representing that three relations may exist. For example, A and/or B may represent following three cases: existence of A alone, existence of both A and B, and existence of B alone. The character “/” generally indicates that the contextual objects are in an “or” relationship. It is also to be understood that “indicate” referred to in the embodiments of the disclosure may be direct indication or indirect indication, or may refer to that there is an association. By way of example, “A indicates B” may refer to that A directly indicates B, for example, B can be acquired through A. “A indicates B” may also refer to that A indirectly indicates B, for example, A indicates C and B can be acquired through C. “A indicates B” may also refer to that there is an association between A and B. It is to be also understood that “correspond” referred to in the embodiments of the disclosure may mean that there is a direct correspondence or indirect correspondence between two objects, or may mean that there is an association relationship between the two object, or may mean a relationship that one object indicates or is indicated by another object or a relationship that one object configures or is configured by another object. It also to be understood that “predefine” or “predefined rule” mentioned in the embodiments of the disclosure may be realized by codes or forms prestored in a device (for example, a terminal device and a network device) or in other ways that can be used to indicate relevant information. The particular implementation is not limited in the disclosure. For example, “predefined” may refer to being defined in a protocol. It is also to be understood that, in the embodiments of the disclosure, the “protocol” may refer to specification protocols in the field of communications, for example, LTE protocols, NR protocols or relevant protocols applied in future communication systems, which is not limited in the embodiments of the disclosure.

For convenience in understanding the technical solutions of the embodiments of the disclosure, the relevant technologies of the embodiments of the disclosure are described hereinafter. Any combination formed by the relevant technologies below as optional solutions and the technical solutions of the embodiments of the disclosure shall fall within the scope of protection of the embodiments of the disclosure.

### Measurement Gap

In order that a terminal device realizes mobility switching better, a network may configure the terminal device to measure a reference signal of a target neighboring cell in a specific time window. The target neighboring cell may be a neighboring cell of a same frequency, or a neighboring cell of a different frequency, or a neighboring cell of a different network. As an example, a measurement quantity of a reference signal may be a reference signal received power (RSRP), or a reference signal received quality (RSRQ), or a signal to interference plus noise ratio (SINR). The measurement time window is referred to as a measurement gap.

In studies on the NR system, two frequency ranges (FRs) are mainly considered, which are FR1 and FR2 respectively. The frequency ranges corresponding to FR1 and FR2 are as illustrated in Table 1 below. FR1 is also referred to as a sub-6 GHz frequency band, and FR2 is also referred to as a millimeter wave band. It is to be noted that, the frequency ranges corresponding to FR1 and FR2 are not limited to the frequency ranges shown in Table 1, and may be adjusted.

TABLE 1

| FR | Range |
|---|---|
| FR1 | 450 MHz-6 GHz |
| FR2 | 24.25 GHz-52.6 GHz |

According to whether a terminal device has the capability of supporting independent operation in FR1 and FR2, measurement gaps are divided into two types, namely, per UE gaps and per FR gaps. Further the per FR gaps are divided into per FR1 gaps and per FR2 gaps. A per UE gap is also referred to as gapUE. A per FR1 gap is also referred to as gapFR1. A per FR2 gap is also referred to as gapFR2. At the same time, the terminal device has introduced a capability indicator about whether independent operation in FR1 and FR2 is supported. The capability indicator is referred to as independentGapConfig. The capability indicator is used for a network to determine whether a measurement gap of the per FR type can be configured, for example, a per FR1 gap and a FR2 gap. In particular, if the capability indicator indicates that the terminal device supports independent operation in FR1 and FR2, the network can configure a measurement gap of the per FR type. If the capability indicator indicates that the terminal device does not support independent operation in FR1 and FR2, the network cannot configure a measurement gap of the per FR type, but can only configure a measurement gap of the per UE type (namely a per UE gap) instead.

The per FR1 gap, the per FR2 gap, and the per UE gap are described below.

Per FR1 gap (i.e., gapFR1): a measurement gap of the per FR1 gap type is applicable for only measurement in FR1. Per FR1 gap and per UE gap cannot be configured at the same time.

In an E-UTRA-NR dual connectivity (EN-DC) mode, a master node (MN) is of an LTE model, and a secondary node (SN) is of an NR model. The per FR1 gap can be configured only by the MN.

Per FR2 gap (i.e., gapFR2): a measurement gap of the per FR2 gap type is applicable for only measurement in FR2. Per FR2 gap and per UE gap cannot be configured at the same time. Per FR2 gap and per FR1 gap can be configured at the same time.

If the terminal device has the capability of supporting independent operation of FR1 and FR2 (i.e., an independent gap capability), the terminal device may perform independent measurement for FR1 and FR2 and the terminal device may be configured with a measurement gap of the per FR gap type, for example, a measurement gap of the per FR1 gap type and a measurement gap of the per FR2 gap type.

Per UE gap (i.e., gapUE): a measurement gap of the per UE gap type is applicable for measurement in all frequency ranges including FR1 and FR2.

In the EN-DC mode, the MN is of the LTE model, and the SN is of the NR model; and only the MN can be configured with the per UE gap. If the terminal device is configured with a per UE gap, the terminal device can be configured with no per FR gap (neither per FR1 gap no per FR2 gap).

In the duration of the measurement gap of the per UE gap, the terminal device is not allowed to send any data and is not expected to adjust a receiver for a primary carrier and a secondary carrier.

### Measurement Configuration

The network configures the measurement configuration (i.e., MeasConfig) by a dedicated RRC signaling. As illustrated in FIG. 2, the MeasConfig includes a measurement gap configuration and a measurement object configuration. The measurement gap configuration is MeasGapConfig, and the measurement object configuration is measObjectToAddModList.

TABLE 2

```
MeasConfig ::= SEQUENCE {
  measObjectToAddModList MeasObjectToAddModList OPTIONAL, --
Need N
  ......
  measGapConfig MeasGapConfig OPTIONAL, -- Need M
}
```

Further, Table 3 below may be referred to for the content of measGapConfig in Table 2. The configuration information of a measurement gap includes: a measurement gap offset (i.e., gapOffset), a measurement gap period (i.e., MGRP), a measurement gap length (i.e., MGL). The measurement gap offset is used for determining a start point of the measurement gap.

TABLE 3

```
MeasGapConfig ::=  SEQUENCE {
    gapFR2  SetupRelease { GapConfig }  OPTIONAL,
    -- Need M
    gapFR1  SetupRelease { GapConfig } OPTIONAL,
    -- Need M
    gapUE  SetupRelease { GapConfig } OPTIONAL
    -- Need M
}
GapConfig ::=  SEQUENCE {
  gapOffset  INTEGER (0..159),
  mgl  ENUMERATED {ms1dot5, ms3, ms3dot5, ms4, ms5dot5, ms6},
  mgrp  ENUMERATED {ms20, ms40, ms80, ms160},
  mgta  ENUMERATED {ms0, ms0dot25, ms0dot5},
```

The type of a measurement gap may be a per UE gap, or a per FR1 gap, or a per FR2 gap. Refer to Table 4, 24 measurement gap patterns (gap patterns for short) are supported. Different gap patterns correspond to different MGRP and/or MGL. Some gap patterns are used for measurement in FR1 and correspond to per FR1 gaps, and some gap patterns are used for measurement in FR2 and correspond to per FR2 gaps.

TABLE 4

| Gap pattern | | |
|---|---|---|
| identifier | MGL (ms) | MGRP (ms) |
| 0 | 6 | 40 |
| 1 | 6 | 80 |
| 2 | 3 | 40 |
| 3 | 3 | 80 |
| 4 | 6 | 20 |
| 5 | 6 | 160 |
| 6 | 4 | 20 |
| 7 | 4 | 40 |
| 8 | 4 | 80 |
| 9 | 4 | 160 |
| 10 | 3 | 20 |
| 11 | 3 | 160 |
| 12 | 5.5 | 20 |
| 13 | 5.5 | 40 |
| 14 | 5.5 | 80 |
| 15 | 5.5 | 160 |
| 16 | 3.5 | 20 |
| 17 | 3.5 | 40 |
| 18 | 3.5 | 80 |
| 19 | 3.5 | 160 |
| 20 | 1.5 | 20 |
| 21 | 1.5 | 40 |
| 22 | 1.5 | 80 |
| 23 | 1.5 | 160 |

Besides the 24 gap patterns shown in Table 4, other gap patterns may also be introduced. For example, a gap pattern for measuring a positioning reference signal (PRS) may be introduced. Refer to Table 5 below, two gap patterns with gap pattern identifiers 24 and 25 are provided. The two gap patterns are used for measuring a PRS.

TABLE 5

| Gap pattern | | |
|---|---|---|
| identifier | MGL (ms) | MGRP (ms) |
| 24 | 10 | 80 |
| 25 | 20 | 160 |

Further, Table 6 is referred to for the content of measObjectToAddModList in Table 2. The configuration information of a measurement object may include a SS/PBCH block measurement timing configuration (SMTC) associated with the measurement object. The SMTC may support a period of {5, 10, 20, 40, 80, 160} ms and a window length of {1, 2, 3, 4, 5} ms. The time offset of the SMTC is strongly correlated to the period, and has a value of {0, . . . , period-1,}. Since the measurement object contains no carrier frequency, the SMTC may be configured according to each measurement object (MO) independently rather than each frequency point.

TABLE 6

```
MeasObjectToAddModList ::=  SEQUENCE (SIZE (1..maxNrofObjectId)) OF
MeasObjectToAddMod
MeasObjectToAddMod ::=  SEQUENCE {
  measObjectId  MeasObjectId,
  measObject  CHOICE {
    measObjectNR  MeasObjectNR,
    ...,
    measObjectEUTRA  MeasObjectEUTRA
  }
}
MeasObjectNR ::=  SEQUENCE {
  ssbFrequency  ARFCN-ValueNR  OPTIONAL, -- Cond
SSBorAssociatedSSB
  ssbSubcarrierSpacing  SubcarrierSpacing  OPTIONAL, -- Cond
SSBorAssociatedSSB
  smtc1  SSB-MTC  OPTIONAL, -- Cond SSBorAssociatedSSB
  smtc2  SSB-MTC2  OPTIONAL, -- Cond IntraFreqConnected
  refFreqCSI-RS  ARFCN-ValueNR  OPTIONAL, -- Cond CSI-RS
  referenceSignalConfig  ReferenceSignalConfig,
  absThreshSS-BlocksConsolidation  ThresholdNR  OPTIONAL, -- Need R
  absThreshCSI-RS-Consolidation ThresholdNR OPTIONAL, -- Need R
  nrofSS-BlocksToAverage INTEGER (2..maxNrofSS-BlocksToAverage)
OPTIONAL, -- Need R
  nrofCSI-RS-ResourcesToAverage INTEGER (2..maxNrofCSI-RS-
ResourcesToAverage) OPTIONAL, -- Need R
  quantityConfigIndex  INTEGER (1..maxNrofQuantityConfig),
  offsetMO  Q-OffsetRangeList,
  cellsToRemoveList  PCI-List  OPTIONAL, -- Need N
  cellsToAddModList  CellsToAddModList  OPTIONAL, -- Need N
  blackCellsToRemoveList  PCI-RangeIndexList  OPTIONAL, -- Need N
  blackCellsToAddModList SEQUENCE (SIZE (1..maxNrofPCI-Ranges)) OF PCI-
RangeElement OPTIONAL, -- Need N
  whiteCellsToRemoveList  PCI-RangeIndexList  OPTIONAL, -- Need N
  whiteCellsToAddModList SEQUENCE (SIZE (1..maxNrofPCI-Ranges)) OF PCI-
RangeElement OPTIONAL, -- Need N
}
```

Refer to Table 7 below, for the intra-frequency measurement in an RRC connected state, a frequency layer may be configured with two SMTCs (SMTC and SMTC2). The two SMTCs have a same time offset but different periods. For inter-frequency measurement in the RRC connected state, only one SMTC is configured. It can be seen that SMTC2 supports only configuration for intra-frequency measurement. It should be noted that, the period of SMTC2 is shorter than that of SMTC, and the time offset of SMTC may be used as that of SMTC2.

TABLE 7

```
SSB-MTC ::=  SEQUENCE {
  periodicityAndOffset  CHOICE {
    sf5 INTEGER (0..4),
    sf10 INTEGER (0..9),
    sf20 INTEGER (0..19),
    sf40 INTEGER (0..39),
    sf80 INTEGER (0..79),
    sf160 INTEGER (0..159) },
  duration ENUMERATED { sf1, sf2, sf3, sf4, sf5 }
}
SSB-MTC2 ::=  SEQUENCE {
  pci-List SEQUENCE (SIZE (1..maxNrofPCIsPerSMTC)) OF PhysCellId
OPTIONAL, -- Need M
  periodicity ENUMERATED {sf5, sf10, sf20, sf40, sf80, spare3, spare2,
spare1}
}
```

At present, when a network configures a measurement gap for a terminal device, only one measurement gap can be configured in a common period. Since the SMTC may be configured according to each MO independently rather than each frequency point, a measurement gap usually cannot cover the time windows of multiple SMTCs or multiple reference signals. Multiple SMTCs may belong to different MOs or the same MO (in the case of intra-frequency). In order to realize measurement in the time windows of multiple MSTCs or to realize measurement for multiple reference signals, it needs very long time to perform the measurement, resulting in low measurement efficiency. Therefore, the following technical solution of the embodiments of the disclosure is provided.

In the technical solution of the embodiment of the disclosure, the two concepts of preconfigured measurement gap (Pre-MG) and concurrent gap are involved. By means of preconfigured measurement gaps and concurrent gaps, the configuration of measurement gaps and measurement of a terminal device can be supported flexibly. The two concepts are described below.

### Preconfigured Measurement Gap

A preconfigured measurement gap can be activated or deactivated. In particular implementation, a network device may activate or deactivate a preconfigured measurement gap by a signaling (for example, an RRC signaling or a MAC-CE), or a terminal device may automatically activate or deactivate the preconfigured measurement gap according to a predefined rule. The predefined rule may be the following rules.

Rule 1: in case of a measurement object change, the preconfigured measurement gap is activated or deactivated. The measurement object change is embodied by at least one of following: adding a measurement object, deleting a measurement object, adding a PSCell, releasing a PSCell, changing a PSCell, activating a PSCell, or deactivating a PSCell.

Rule 2: in case of a BWP change, the preconfigured measurement gap is activated or deactivated. If the bandwidth of a configured synchronization signal block (SSB) needing to be measured is not completely contained in an activated BWP, then the preconfigured measurement gap is activated. If the bandwidth of the configured SSB needing to be measured is completely contained in the activated BWP, then the preconfigured measurement gap is deactivated.

Activating or deactivating the preconfigured measurement gap is based on the principle that: if none of configured measurements needs a preconfigured measurement gap, the preconfigured measurement gap is deactivated; and if any of configured measurements needs a preconfigured measurement gap, the preconfigured measurement gap is activated.

### Concurrent Gaps

The concurrent gaps include multiple measurement gaps. The multiple measurement gaps are configured in the same time period and/or the multiple measurement gaps are used for measurement in the same time period.

Here, the multiple measurement gaps are concurrent. In some optional implementations, the concurrency of multiple measurement gaps may be embodied in that the multiple measurement gaps are configured in the same time period. In some optional embodiments, the concurrency of multiple measurement gaps may be embodied in that the multiple measurement gaps are used for the measurement in the same time period.

When configuring the concurrent gaps for the terminal device, the network device considers the following use cases: SMTC configuration, reference signals (such as SSB, channel state information reference signal (CSI-RS), positioning reference signal (PRS), received signal strength indicator (RSSI), and radio access technology (RAT).

In addition, when configuring the concurrent gaps for the terminal device, the network device also considers the maximum number or total number of some type of measurement gaps (such as per-UE gaps, FR1-gaps, or FR2-gaps) in the concurrent gaps.

In addition, when configuring the concurrent gaps for the terminal device, the network device also considers the association between the above use cases. One measurement gap may be associated with multiple frequency layers (the multiple frequency layers may belong to the same use case or different use cases), and one frequency layer is associated with only one measurement gap. Different reference signals are considered as different frequency layers. For example, different reference signals such as SSB, CSI-RS and PRS are considered as different frequency layers.

For convenience of understanding the technical solution of the embodiments of the disclosure, the technical solution of the disclosure will be described in detail via particular embodiments. Any combination formed by the above relevant technologies as optional solutions and the technical solutions of the embodiments of the disclosure shall fall within the scope of protection of the embodiments of the disclosure. The embodiments of the disclosure include at least part of the following content.

The technical solution of the embodiments of the disclosure provides a method for measurement gap enhancement in a carrier aggregation (CA) or a dual connectivity (DC) network architecture, to flexibly support configuration of measurement gaps and measurement of a terminal device.

FIG. 2 illustrates a schematic flowchart of a method for measurement gap enhancement according to embodiments of the disclosure. As illustrated in FIG. 2, the method for measurement gap enhancement includes following operation.

Operation 201: a terminal device receives configuration information of concurrent gaps. The concurrent gaps include multiple measurement gaps. At least part of the multiple measurement gaps are preconfigured measurement gaps, and the preconfigured measurement gaps are capable of being activated or deactivated.

In the embodiments of the disclosure, the network device sends configuration information of the concurrent gaps, and accordingly, the terminal device receives the configuration information of the concurrent gaps. The concurrent gaps include multiple measurement gaps. Here, the multiple measurement gaps are concurrent.

In some optional implementations, the concurrency of multiple measurement gaps may be embodied in that the multiple measurement gaps are configured in the same time period.

In some optional embodiments, the concurrency of multiple measurement gaps may be embodied in that the multiple measurement gaps are used for the measurement in the same time period.

It should be noted that, for a measurement gap, the gap type of the measurement gap may be a per UE gap, or a per FR1 gap, or a per FR2 gap. Further, a per FR gap may be divided into a per FR1 gap and a per FR2 gap. The gap pattern of the measurement gap may be, but not limited to, any of the gap patterns as shown in Table 4 or Table 5. The gap pattern of the measurement gap may also be other newly introduced gap patterns.

It should be noted that, if concurrent gaps are not considered, the terminal device in a dual connectivity mode (such as EN-DC and NE-DC) or in an NOR standalone (NRSA) mode can be configured with only one measurement gap, and the measurement gap may be a per UE gap or a per FR gap. If the terminal device is configured with only a preconfigured measurement gap (Pre-MG), once the preconfigured measurement gap is deactivated, the terminal device performs no measurement that needs a measurement gap or performs measurement that needs no measurement gap, and normally performs data transceiving on a serving carrier.

In the embodiments of the disclosure, concurrent gaps are considered, and the case that the concurrent gaps include preconfigured measurement gaps is considered. When the network device configures the concurrent gaps for the terminal device, specific limitations should be satisfied. Particularly, the concurrent gaps satisfy at least one of following limitations.

Limitation 1: the concurrent gaps satisfy at least one of following:
a total number of measurement gaps in the multiple measurement gaps is smaller than or equal to a first number;
a number of per UE gaps in the multiple measurement gaps is smaller than or equal to a second number;
a number of per FR1 gaps in the multiple measurement gaps is smaller than or equal to a third number; or
a number of per FR2 gaps in the multiple measurement gaps is smaller than or equal to a fourth number.

The limitation can be realized by capability information supported by the terminal device. In some optional implementations, the terminal device reports first capability information supported by the terminal device, and the network device receives the first capability information reported by the terminal device. The first capability information is used for indicating at least one of following:
a total number of measurement gaps supported by the terminal device is not greater than the first number;
a number of per UE gaps supported by the terminal device is not greater than the second number;
a number of per FR1 gaps supported by the terminal device is not greater than the third number; or
a number of per FR2 gaps supported by the terminal device is not greater than the fourth number.

It should be noted that besides the preconfigured measurement gap, the concurrent gaps may optionally further include a legacy measurement gap (legacy MG). For the limitation 1, when counting the number of measurement gaps, configured measurement gaps are considered. The configured measurement gaps need to be counted in, no matter they are preconfigured measurement gaps or legacy measurement gaps.

Limitation 2: the concurrent gaps satisfy at least one of following:
a total number of activated measurement gaps in the multiple measurement gaps is smaller than or equal to a fifth number;
a number of activated per UE gaps in the multiple measurement gaps is smaller than or equal to a sixth number;
a number of activated per FR1 gaps is smaller than or equal to a seventh number; or
a number of activated per FR2 gaps in the multiple measurement gaps is smaller than or equal to an eighth number.

The limitation can be realized by capability information supported by the terminal device. In some optional implementations, the terminal device reports second capability information supported by the terminal device, and the network device receives the second capability information reported by the terminal device. The second capability information is used for indicating at least one of following:
a total number of activated measurement gaps supported by the terminal device is not greater than the fifth number;
a number of activated per UE gaps supported by the terminal device is not greater than the sixth number;
a number of activated per FR1 gaps supported by the terminal device is not greater than the seventh number; or
a number of activated per FR2 gaps supported by the terminal device is not greater than the eighth number.

It should be noted that besides the preconfigured measurement gap, the concurrent gaps may optionally further include a legacy measurement gap (legacy MG). Once a legacy measurement gap is configured, it is considered that the legacy measurement gap is activated. After being configured, a preconfigured measurement gap needs to be activated by an activation command. For the limitation 2, when counting activated measurement gaps, it is possible to consider activated configured measurement gaps only, or to consider both the activated preconfigured measurement gaps and configured legacy measurement gaps.

On this basis, in some optional implementations, the total number of activated measurement gaps is equal to a number of activated preconfigured measurement gaps; or the total number of activated measurement gaps is equal to a sum of the number of activated preconfigured measurement gaps plus a number of legacy measurement gaps in the multiple measurement gaps.

In some optional implementations, the number of activated per UE gaps is equal to a number of activated first-type preconfigured measurement gaps; or the number of activated per UE gaps is equal to a sum of the number of activated first-type preconfigured measurement gaps plus a number of first-type legacy measurement gaps in the multiple measurement gaps. The first-type preconfigured measurement gaps are preconfigured measurement gaps that are per UE gaps, and the first-type legacy measurement gaps are legacy measurement gaps that are per UE gaps.

In some optional implementations, the number of activated per FR1 gaps is equal to a number of activated second-type preconfigured measurement gaps; or the number of activated per FR1 gaps is equal to a sum of the number of activated second-type preconfigured measurement gaps plus a number of second-type legacy measurement gaps in the multiple measurement gaps. The second-type preconfigured measurement gaps are preconfigured measurement gaps that are per FR1 gaps, and the second-type legacy measurement gaps are legacy measurement gaps that are per FR1 gaps.

In some optional implementations, the number of activated per FR2 gaps is equal to a number of activated third-type preconfigured measurement gaps; or the number of activated per FR2 gaps is equal to a sum of the number of activated third-type preconfigured measurement gaps plus a number of third-type legacy measurement gaps in the multiple measurement gaps. The third-type preconfigured measurement gaps are preconfigured measurement gaps that are per FR2 gaps, and the third-type legacy measurement gaps are legacy measurement gaps that are per FR2 gaps.

Optionally, when counting a maximum number of supported measurement gaps, preconfigured measurement gaps and legacy measurement gaps may be counted separately, and it should be satisfied that a maximum number of preconfigured measurement gaps and a maximum number of legacy measurement gaps are not exceeded respectively. Further, for a preconfigured measurement gap, optionally, whether the measurement gap is in an activated state may not be considered; and the preconfigured measurement gap will be counted once configured. Satisfying requirements in a maximum number of gaps includes: satisfying requirements in the respective numbers of different types of measurement gaps (per UE or per FR) and the total number of measurement gaps.

Table 8 below gives some limitations satisfied by the concurrent gaps. The concurrent gaps may satisfy one of the limitations in Table 8 below, and each of the limitations corresponds to a respective index.

TABLE 8

| | Limitation in number of simultaneously | | |
|---|---|---|---|
| | configured measurement gaps | | |
| Index(s) | per FR2 gap | per FR2 gap | per UE gap |
| 0 | 2 | 1 | 0 |
| 1 | 1 | 2 | 0 |
| 2 | 0 | 0 | 2 |
| 3 | 1 | 0 | 1 |
| 4 | 0 | 1 | 1 |
| 5 | 1 | 1 | 1 |
| 6 | 2 | 2 | 0 |
| 7 | 0 | 0 | 1 |
| 8 | 1 | 1 | 0 |
| 9 | 1 | 0 | 0 |
| 10 | 0 | 1 | 0 |

According to the capability information reported by the terminal device, the network deice configures concurrent gaps satisfying the limitations for the terminal device.

In the embodiments of the disclosure, the concurrent gaps are configured by different network node under different network scenarios. How to configure the concurrent gaps is described in combination with different network scenarios. It should be noted that, in the following description, the MN may also be replaced with a primary cell (PSCell), and the SN may also be replaced with a primary secondary cell (PSCell)

In an NR SA scenario, the multiple measurement gaps are all configured by the MN.

In an NR-DC scenario, a first portion of the multiple measurement gaps are configured by the MN, and a second portion of the multiple measurement gaps are configured by the SN. Alternatively, the multiple measurement gaps are all configured by the MN.

In a multi-rate duel connectivity (MR-DC) scenario, a first portion of the multiple measurement gaps are configured by the MN, and a second portion of the multiple measurement gaps are configured by the SN. Alternatively, the multiple measurement gaps are all configured by the MN.

In the embodiments of the disclosure, if a first portion of the multiple measurement gaps are configured by the MN and a second portion of the multiple measurement gaps are configured by the SN, then some information may be negotiated between the MN and the SN so that the multiple measurement gaps configured by the MN and SN together satisfy the limitations in the above solution.

In some optional implementations, the network device sends first indication information and the terminal device receives the first indication information. The first indication information is used for indicating: for each of N bandwidth parts (BWPs), whether the preconfigured measurement gaps are activated when the BWP is activated, N being a positive integer. Further, optionally, in a case that a number of the preconfigured measurement gaps is more than one, the first indication information is further used for indicating identifiers of the preconfigured measurement gaps.

As an example, Table 9 below shows whether the preconfigured measurement gaps are activated when each of 3 BWP is activated. Whether the preconfigured measurement gaps are activated is indicated by the value of one bit. When the value of the bit is 1, it indicates that the preconfigured measurement gaps are activated (that is, the preconfigured measurement gaps are in an activated state). When the value of the bit is 0, it indicates that the preconfigured measurement gaps are deactivated (that is, the preconfigured measurement gaps are in a deactivated state) When the terminal device is switched to BWP2, it may be determined through the first indication information that the Pre-MG is activated when the BWP2 is activated.

TABLE 9

| When BWP is | Activated/deactivated |
|---|---|
| activated | state of Pre-MG |
| BWP1 | 0 |
| BWP2 | 1 |
| BWP3 | 1 |

In some optional implementations, the terminal device acquires first configuration information. The first configuration information is used for configuring an associated measurement configuration corresponding to the preconfigured measurement gaps, and the associated measurement configuration is used for determining a use case associated with the preconfigured measurement gaps. Further, in a case that a number of the preconfigured measurement gaps is more than one, the first configuration information is used for configuring a corresponding associated measurement configuration for each of the preconfigured measurement gaps.

In the above solution, the first configuration information is predefined; or the first configuration information is configured by a radio resource control (RRC) signaling (correspondingly, the network device sends the first configuration information, and the first configuration information is configured by the RRC signaling). Further, optionally, in a case that the first configuration information is configured by the RRC signaling, the first configuration information is carried in an RRC signaling for configuring measurement configuration information (such as measconfig). Optionally, the first configuration information is carried in an RRC signaling for configuring configuration information (such as measgapconfig) of the concurrent gaps.

Further, optionally, the first configuration information further carries first indication information. The first indication information is used for indicating: for each of N bandwidth parts (BWPs), whether the preconfigured measurement gaps are activated when the BWP is activated, N being a positive integer. Alternatively, the first configuration information further carries a first BWP ID list (including at least one BWP ID) and/or a second BWP ID list (including at least one BWP ID). When a BWP indicated in the first BWP ID list is activated, the preconfigured measurement gaps are activated; and when a BWP indicated in the second BWP ID list is activated, the preconfigured measurement gaps are deactivated

Here, similar to legacy measurement gaps, an associated use case also needs to be configured for the preconfigured measurement gaps. In the disclosure, the configured “associated use case” is also referred to as “associated measurement configuration”. Optionally, the associated measurement configuration is used for determining at least one of following: SMTC configuration, reference signals (such as SSB, CSI-RS, PRS, RSSI), and RAT. It should be noted that, each measurement gap may be associated with multiple frequency layers (the multiple frequency layers may belong to the same use case or different use cases), and each frequency layer is associated with only one measurement gap. Different reference signals are considered as different frequency layers. For example, different reference signals such as SSB, CSI-RS and PRS are considered as different frequency layers. As an example, the concurrent gaps include Pre-MG1 and Pre-MG2. Pre-MG1 is associated with CSI-RSI and SSB1, and Pre-MG2 is associated with SSB2 or PRS.

In the embodiments of the disclosure, all of the multiple measurement gaps are preconfigured measurement gaps; or a first portion of the multiple measurement gaps are preconfigured measurement gaps, and a second portion of the multiple measurement gaps are legacy measurement gaps. The technical solutions of the embodiments of the disclosure are described below in combination with two situations.

### Situation I

In some optional implementations, all of the multiple measurement gaps are preconfigured measurement gaps. In a case that a BWP is switched:
if a measurement object does not change, the associated measurement configuration corresponding to the preconfigured measurement gaps does not change; and
if the measurement object changes, the associated measurement configuration corresponding to the preconfigured measurement gaps is determined based on a network configuration.

### Situation II

In some optional implementations, a first portion of the multiple measurement gaps are preconfigured measurement gaps, and a second portion of the multiple measurement gaps are legacy measurement gaps. In a case that a BWP is switched:
if a measurement object is not changed, the associated measurement configuration corresponding to the preconfigured measurement gaps and an associated measurement configuration corresponding to the legacy measurement gaps do not change; and
if the measurement object changes, the associated measurement configuration corresponding to the preconfigured measurement gaps and/or the associated measurement configuration corresponding to the legacy measurement gaps are/is determined based on a network configuration.

In the above solution, the change in the measurement object may be embodied by at least one of following: adding a measurement object, deleting a measurement object, adding a PSCell, releasing a PSCell, changing a PSCell, activating a PSCell, or deactivating a PSCell.

In the above solution, the associated measurement configuration corresponding to the preconfigured measurement gaps may be configured in following manners.

### Manner I

In some optional implementations, the network device sends second configuration information and the terminal device receives the second configuration information. The second configuration information is used for configuring: for each of M bandwidth parts (BWPs), an associated measurement configuration corresponding to the preconfigured measurement gaps when the BWP is activated, M being a positive integer.

Further, in a case that a number of the preconfigured measurement gaps is more than one, the second configuration information is used for configuring: for each of M BWPs, a corresponding associated measurement configuration for each of the preconfigured measurement gaps when the BWP is activated, M being a positive integer.

In some optional implementations, the second configuration information is configured by a radio resource control (RRC) signaling or a media access control (MAC) control clement (CE). Optionally, the RRC signaling for configuring the associated measurement configuration is contained in an RRC signaling for configuring the BWP. Alternatively, the MAC CE for configuring the associated measurement configuration is contained in a MAC CE for indicating BWP switching.

In some optional implementations, the second configuration information may be the same configuration information as the first configuration information in the foregoing solution, or may be configuration information different from the first configuration information in the foregoing solution. Optionally, the second configuration information is contained in the first configuration information in the foregoing solution.

For the manner I, when a BWP is switched, the associated measurement configuration corresponding to the preconfigured measurement gaps may change.

### Manner II

In some optional implementations, the network device sends second configuration information and the terminal device receives the second configuration information. The second configuration information is used for configuring an associated measurement configuration corresponding to the preconfigured measurement gaps. The second configuration information is carried in a measurement gap configuration corresponding to the preconfigured measurement gaps. The associated measurement configuration corresponding to the preconfigured measurement gaps does not change when a BWP is switched.

In some optional implementations, the second configuration information is carried in a radio resource control (RRC) configuration signaling or an RRC reconfiguration signaling or an RRC reestablishment signaling. Here, the second configuration information may be the same configuration information as the first configuration information in the foregoing solution, or may be configuration information different from the first configuration information in the foregoing solution.

In the above solution, the associated measurement configuration corresponding to the legacy measurement gaps may be configured in following manners.

### Manner A

In some optional implementations, the network device sends third configuration information and the terminal device receives the third configuration information. The third configuration information is used for configuring: for each of M bandwidth parts (BWPs), an associated measurement configuration corresponding to the legacy measurement gaps when the BWP is activated, M being a positive integer.

Further, in a case that a number of the legacy measurement gaps is more than one, the third configuration information is used for configuring: for each of M BWPs, a corresponding associated measurement configuration for each of the legacy measurement gaps when the BWP is activated, M being a positive integer.

In some optional implementations, the third configuration information is configured by a radio resource control (RRC) signaling or a media access control (MAC) control element (CE). Optionally, the RRC signaling for configuring the associated measurement configuration is contained in an RRC signaling for configuring the BWP. Alternatively, the MAC CE for configuring the associated measurement configuration is contained in a MAC CE for indicating BWP switching.

For the manner A, when a BWP is switched, the associated measurement configuration corresponding to the legacy measurement gaps may change.

### Manner B

In some optional implementations, the network device sends third configuration information and the terminal device receives the third configuration information. The third configuration information is used for configuring an associated measurement configuration corresponding to the legacy measurement gaps. The third configuration information is carried in a measurement gap configuration corresponding to the legacy measurement gaps. The associated measurement configuration corresponding to the legacy measurement gaps does not change when a BWP is switched.

In some optional implementations, the third configuration information is carried in a radio resource control (RRC) configuration signaling or an RRC reconfiguration signaling or an RRC reestablishment signaling.

It should be noted that in the above solution, the associated measurement configuration corresponding to the preconfigured measurement gaps may also be understood as association between preconfigured measurement gaps and use cases. The use case includes for example, a reference signal (RS) type and SMTC configuration.

The above solution is described by way of example hereinafter in combination with particular application examples.

### Application Example I

A terminal device receives configuration information of concurrent gaps. The concurrent gaps include multiple measurement gaps that are all preconfigured measurement gaps.

Situation I: if a measurement object does not change, the associated measurement configuration corresponding to the preconfigured measurement gaps does not change in a case that a BWP is switched.

Situation II: if the measurement object changes, the associated measurement configuration corresponding to the preconfigured measurement gaps depends on a network configuration in a case that a BWP is switched. The associated measurement configuration corresponding to the preconfigured measurement gaps may be configured in following manners.

### Manner I

The associated measurement configuration corresponding to the preconfigured measurement gaps may be configured as per BWP together with an activation/deactivation flag (0/1) of the preconfigured measurement gaps. The associated measurement configuration corresponding to the preconfigured measurement gaps may be configured by an RRC signaling or a MAC CE. For some preconfigured measurement gap, the associated measurement configuration corresponding to the preconfigured measurement gap may change as the BWP is switched, which is similar to that the activation/deactivation of the preconfigured measurement gap also changes as the BWP is switched. With the associated measurement configuration including a configuration of a reference signal as an example, the preconfigured measurement gap (Pre-MG) is associated to different reference signals when different BWPs are activated respectively. Table 10 below provides the reference signals associated with Pre-MG-1 when three BWPs are activated respectively, and the reference signals associated with Pre-MG-2 when three BWPs are activated respectively. It can be seen that when the terminal device is switched to a different BWP, the reference signal associated with Pre-MG-1/Pre-MG-2 changes.

TABLE 10

| | | Associated | |
|---|---|---|---|
| When BWP | Activation state | measurement | |
| is activated | of Pre-MG-1 | configuration | Explanation |
| BWP1 | 0 | SSB1 | For example, when the |
| BWP2 | 1 | SSB1 + PRS1 | BWP3 is activated, the CSI- |
| BWP3 | 1 | SSB1 + CSI-RS1 | RS measurement is inter- |
| | | | frequency measurement |
| | | | and needs a gap to be |
| | | | configured; and when the |
| | | | BWP 1/2 is activated, the |
| | | | CSI-RS measurement is |
| | | | intra-frequency |
| | | | measurement and needs no |
| | | | gap. |
| When BWP | Activation state | | |
| is activated | of Pre-MG-2 | Association | Explanation |
| BWP1 | 1 | SSB2 | For example, when the |
| BWP2 | 0 | SSB2 + PRS2 | BWP3 is activated, the CSI- |
| BWP3 | 1 | SSB2 + CSI-RS2 | RS measurement is inter- |
| | | | frequency measurement |
| | | | and needs a gap to be |
| | | | configured; and when the |
| | | | BWP 1/2 is activated, the |
| | | | CSI-RS measurement is |
| | | | intra-frequency |
| | | | measurement and needs no |
| | | | gap. |

### Manner II

The associated measurement configuration corresponding to the preconfigured measurement gaps is configured together with configuration information of the preconfigured measurement gaps (e.g., per UE/FR MG configuration) carried in an RRC configuration signaling or an RRC reconfiguration signaling or an RRC reestablishment signaling. Once a preconfigured measurement gap is configured, then the associated measurement configuration corresponding to the preconfigured measurement gap does not change with activation or deactivation of the preconfigured measurement gap or with switching of a BWP. Table 11 below provides the reference signals associated with Pre-MG-1 when three BWPs are activated respectively, and the reference signals associated with Pre-MG-2 when three BWPs are activated respectively. It can be seen that when the terminal device is switched to a different BWP, the reference signal associated with Pre-MG-1/Pre-MG-2 does not change.

TABLE 11

| | | Associated |
|---|---|---|
| When BWP | Activation state | measurement |
| is activated | of Pre-MG-1 | configuration |
| BWP1 | 0 | SSB1 |
| BWP2 | 1 | |
| BWP3 | 1 | |
| | | Associated |
| When BWP | Activation state | measurement |
| is activated | of Pre-MG-2 | configuration |
| BWP1 | 0 | PRS2 |
| BWP2 | 1 | |
| BWP3 | 1 | |

### Application Example II

A terminal device receives configuration information of concurrent gaps. The concurrent gaps include multiple measurement gaps. A first portion of the multiple measurement gaps are preconfigured measurement gaps, and a second portion of the multiple measurement gaps are legacy measurement gaps.

Situation I: if a measurement object does not change, but a BWP is switched, the associated measurement configuration corresponding to the preconfigured measurement gaps and the associated measurement configuration corresponding to the legacy measurement gaps do not change.

Situation II: if the measurement object changes, the associated measurement configuration corresponding to the preconfigured measurement gaps and/or the associated measurement configuration corresponding to the legacy measurement gaps depend(s) on a network configuration in a case that a BWP is switched. For example, the associated measurement configuration corresponding to the preconfigured measurement gaps depends on a network configuration, and the associated measurement configuration corresponding to the legacy measurement gaps does not change. For another example, the associated measurement configuration corresponding to the preconfigured measurement gaps and the associated measurement configuration corresponding to the legacy measurement gaps depend on a network configuration.

The associated measurement configuration corresponding to the preconfigured measurement gaps and the associated measurement configuration corresponding to the legacy measurement gaps may be configured in following manners.

### Manner I

The associated measurement configuration corresponding to the preconfigured measurement gaps may be configured as per BWP together with an activation/deactivation flag (0/1) of the preconfigured measurement gaps. The associated measurement configuration corresponding to the preconfigured measurement gaps may be configured by an RRC signaling or a MAC CE. The associated measurement configuration corresponding to the legacy measurement gaps may be configured as per BWP. The associated measurement configuration corresponding to the legacy measurement gaps may be configured by an RRC signaling or a MAC CE. For some preconfigured measurement gap, the associated measurement configuration corresponding to the preconfigured measurement gap may change as the BWP is switched, which is similar to that the activation/deactivation of the preconfigured measurement gap also changes as the BWP is switched. For some legacy measurement gap, the associated measurement configuration corresponding to the legacy measurement gap may change as the BWP is switched. With the associated measurement configuration including a configuration of a reference signal as an example, the preconfigured measurement gap (Pre-MG) is associated to different reference signals when different BWPs are activated respectively, and the legacy measurement gap (legacy MG) is associated to different reference signals when different BWPs are activated respectively. Table 12 below provides the reference signals associated with Pre-MG-1 when three BWPs are activated respectively, and the reference signals associated with legacy-MG-2 when three BWPs are activated respectively. It can be seen that when the terminal device is switched to a different BWP, the reference signal associated with Pre-MG-1/legacy-MG-2 changes.

TABLE 12

| | Activation | Associated | |
|---|---|---|---|
| When BWP is | state of | measurement | |
| activated | Pre-MG-1 | configuration | Explanation |
| BWP1 | 0 | SSB1 | For example, when |
| BWP2 | 1 | SSB1 + PRS1 | the BWP3 is |
| BWP3 | 1 | SSB1 + CSI-RS1 | activated, the CSI-RS |
| | | | measurement is inter- |
| | | | frequencymeasurement and |
| | | | needs a gap to beconfigured; |
| | | | and when the BWP 1/2 is |
| | | | activated, the CSI-RS |
| | | | measurement is intra- |
| | | | frequency measurement |
| | | | and needs no gap |
| | legacy- | Associated | |
| When BWP is | MG-2(always | measurement | |
| activated | activated) | configuration | Explanation |
| BWP1 | N/A | SSB2 | For example, when |
| BWP2 | | SSB2 + PRS2 | the BWP3 is |
| BWP3 | | SSB2 + CSI-RS2 | activated, the CSI-RS |
| | | | measurement is inter- |
| | | | frequencymeasurement and |
| | | | needs a gap to beconfigured; |
| | | | and when the BWP 1/2 is |
| | | | activated, the CSI-RS |
| | | | measurement is intra- |
| | | | frequency measurement |
| | | | and needs no gap |

### Manner II

The associated measurement configuration corresponding to the preconfigured measurement gaps and the associated measurement configuration corresponding to the legacy measurement gaps are configured together with configuration information of measurement gaps (e.g., per UE/FR MG configuration) carried in an RRC configuration signaling or an RRC reconfiguration signaling or an RRC reestablishment signaling. Once a preconfigured measurement gap and a legacy measurement gap are configured, then the associated measurement configuration corresponding to the preconfigured measurement gap and the associated measurement configuration corresponding to the legacy measurement gap do not change with switching of a BWP. Table 12 below provides the reference signals associated with Pre-MG-1 when three BWPs are activated respectively, and the reference signals associated with legacy-MG-2 when three BWPs are activated respectively. It can be seen that when the terminal device is switched to a different BWP, the reference signal associated with Pre-MG-1/legacy-MG-2 does not change.

TABLE 12

| | | Associated |
|---|---|---|
| When BWP | Activation state | measurement |
| is activated | of Pre-MG-1 | configuration |
| BWP1 | 0 | SSB1 |
| BWP2 | 1 | |
| BWP3 | 1 | |
| | legacy- | Associated |
| When BWP | MG-2(always | measurement |
| is activated | activated) | configuration |
| BWP1 | N/A | PRS2 |
| BWP2 | | |
| BWP3 | | |

### Manner III

The associated measurement configuration corresponding to the preconfigured measurement gaps may be configured as per BWP together with an activation/deactivation flag (0/1) of the preconfigured measurement gaps. The associated measurement configuration corresponding to the preconfigured measurement gaps may be configured by an RRC signaling or a MAC CE. The associated measurement configuration corresponding to the legacy measurement gaps is configured together with configuration information of measurement gaps (e.g., per UE/FR MG configuration) carried in an RRC configuration signaling or an RRC reconfiguration signaling or an RRC reestablishment signaling. Once a legacy measurement gap is configured, then the associated measurement configuration corresponding to the legacy measurement gap does not change with switching of a BWP. Table 13 below provides the reference signals associated with Pre-MG-1 when three BWPs are activated respectively, and the reference signals associated with legacy-MG-2 when three BWPs are activated respectively. It can be seen that when the terminal device is switched to a different BWP, the reference signal associated with Pre-MG-1 changes, and the reference signal associated with legacy-MG-2 does not change.

TABLE 13

| | | Associated |
|---|---|---|
| When BWP | Activation state | measurement |
| is activated | of Pre-MG-1 | configuration |
| BWP1 | 0 | SSB1 |
| BWP2 | 1 | SSB1 + PRS1 |
| BWP3 | 1 | SSB1 + CSI-RS1 |
| | legacy- | Associated |
| When BWP | MG-2(always | measurement |
| is activated | activated) | configuration |
| BWP1 | N/A | PRS2 |
| BWP2 | | |
| BWP3 | | |

### Manner IV

The associated measurement configuration corresponding to the preconfigured measurement gaps is configured together with configuration information of measurement gaps (e.g., per UE/FR MG configuration) carried in an RRC configuration signaling or an RRC reconfiguration signaling or an RRC reestablishment signaling. Once a preconfigured measurement gap is configured, then the associated measurement configuration corresponding to the preconfigured measurement gap does not change with switching of a BWP. The associated measurement configuration corresponding to the legacy measurement gaps may be configured as per BWP. The associated measurement configuration corresponding to the legacy measurement gaps may be configured by an RRC signaling or a MAC CE. For some legacy measurement gap, the associated measurement configuration corresponding to the legacy measurement gap may change as the BWP is switched. Table 14 below provides the reference signals associated with Pre-MG-1 when three BWPs are activated respectively, and the reference signals associated with legacy-MG-2 when three BWPs are activated respectively. It can be seen that when the terminal device is switched to a different BWP, the reference signal associated with Pre-MG-1 does not change, and the reference signal associated with legacy-MG-2 changes.

TABLE 14

| | | Associated |
|---|---|---|
| When BWP | Activation state | measurement |
| is activated | of Pre-MG-1 | configuration |
| BWP1 | 0 | SSB1 |
| BWP2 | 1 | |
| BWP3 | 1 | |
| | legacy- | Associated |
| When BWP | MG-2(always | measurement |
| is activated | activated) | configuration |
| BWP1 | N/A | SSB2 |
| BWP2 | | SSB2 + PRS2 |
| BWP3 | | SSB2 + CSI-RS2 |

The technical solutions of the embodiments of the disclosure provide a scheme of measurement gap enhancement under a carrier aggregation-dual connectivity (CA/DC) network architecture. Preconfigured measurement gaps are supported, while introducing concurrent gaps. It is realized that a network configures preconfigured measurement gaps and other legacy measurement gaps in the concurrent gaps. Activation and deactivation of the preconfigured measurement gaps are realized. The associated measurement configuration corresponding to the preconfigured measurement gaps is realized. By implementing the technical solutions of the embodiments of the disclosure, it is ensured that a base station and a network reach a unified understanding in measurement gap configuration, efficiently and correctly realizing concurrent measurement in multiple measurement gaps. Some frequency points or measurement gaps are flexibly matched in batches. The concurrent gaps formed by multiple measurement gaps can avoid increased network signaling overhead and delay caused by repeated RRC configurations, thereby improving the measurement efficiency of RRM/PRS.

Preferred implementations of the disclosure are described in detail in combination with accompanying drawings. However, the disclosure is not limited to the particular details in the above implementations. Within the range of the technical idea of the disclosure, multiple simple variations can be made to the technical solutions of the disclosure, and these variations all fall within the scope of protection of the disclosure. For example, the particular technical features described in the above particular implementations may be combined in any suitable way without conflict. To avoid unnecessary repetition, the possible combinations are not described in the disclosure. For example, different implementations of the disclosure may also be combined arbitrarily without departing from the concept of the disclosure, which shall be considered as content disclosed by the disclosure as well. For another, without conflict, the various embodiments described in the disclosure and/or technical features of the various embodiments may be combined with the related art arbitrarily, and the technical solutions obtained via the combination shall also fall within the scope of protection of the disclosure.

It is also to be understood that, in the method embodiments of the disclosure, the sizes of the serial numbers of the above operations do not imply the sequential order in which the operations are performed, and shall not construe any limitation to the implementation of the embodiments of the disclosure. The order in which the operations are performed should be decided by their functions and internal logics. In addition, in the embodiments of the disclosure, the terms “downlink”, “uplink” and “sidelink” are used for representing the transmission direction of signals or data. “Downlink” is used for representing the transmission direction of signals or data is a first direction of sending from a station to user equipment in a cell. “Uplink” is used for representing the transmission direction of signals or data is a second direction of sending from user equipment in a cell to a station. “Sidelink” is used for representing the transmission direction of signals or data is a third direction of sending from user equipment 1 to user equipment 2. For example, “downlink signal” represents that the transmission signal of the direction is the first signal. In addition, in the embodiments of the disclosure, the term “and/or” herein merely describes a relation between associated objects, representing that three relations may exist. In particular, A and/or B may represent following three cases: existence of A alone, existence of both A and B, and existence of B alone. The character “/” generally indicates that the contextual objects are in an “or” relationship.

FIG. 3 illustrates a first schematic diagram of structural composition of an apparatus for measurement gap enhancement according to embodiments of the disclosure. As illustrated in FIG. 3, the apparatus for measurement gap enhancement is applied to a terminal device, and includes a receiving unit 301.

The receiving unit 301 is configured to: receive configuration information of concurrent gaps. The concurrent gaps include multiple measurement gaps, at least part of the multiple measurement gaps are preconfigured measurement gaps, and the preconfigured measurement gaps are capable of being activated or deactivated.

In some optional implementations, the concurrent gaps satisfy at least one of following: a total number of measurement gaps in the multiple measurement gaps is smaller than or equal to a first number; a number of per UE gaps in the multiple measurement gaps is smaller than or equal to a second number; a number of per FR1 gaps in the multiple measurement gaps is smaller than or equal to a third number; or a number of per FR2 gaps in the multiple measurement gaps is smaller than or equal to a fourth number.

In some optional implementations, the apparatus further includes a sending unit 302.

The sending unit 302 is configured to report first capability information supported by the terminal device. The first capability information is used for indicating at least one of following: a total number of measurement gaps supported by the terminal device is not greater than the first number; a number of per UE gaps supported by the terminal device is not greater than the second number; a number of per FR1 gaps supported by the terminal device is not greater than the third number; or a number of per FR2 gaps supported by the terminal device is not greater than the fourth number.

In some optional implementations, the concurrent gaps satisfy at least one of following: a total number of activated measurement gaps in the multiple measurement gaps is smaller than or equal to a fifth number; a number of activated per UE gaps in the multiple measurement gaps is smaller than or equal to a sixth number; a number of activated per FR1 gaps is smaller than or equal to a seventh number; or a number of activated per FR2 gaps in the multiple measurement gaps is smaller than or equal to an eighth number.

In some optional implementations, the apparatus further includes a sending unit 302.

The sending unit is configured to report second capability information supported by the terminal device. The second capability information is used for indicating at least one of following: a total number of activated measurement gaps supported by the terminal device is not greater than the fifth number; a number of activated per UE gaps supported by the terminal device is not greater than the sixth number; a number of activated per FR1 gaps supported by the terminal device is not greater than the seventh number; or a number of activated per FR2 gaps supported by the terminal device is not greater than the eighth number.

In some optional implementations, the total number of activated measurement gaps is equal to a number of activated preconfigured measurement gaps; or the total number of activated measurement gaps is equal to a sum of the number of activated preconfigured measurement gaps plus a number of legacy measurement gaps in the multiple measurement gaps.

In some optional implementations, the number of activated per UE gaps is equal to a number of activated first-type preconfigured measurement gaps; or the number of activated per UE gaps is equal to a sum of the number of activated first-type preconfigured measurement gaps plus a number of first-type legacy measurement gaps in the multiple measurement gaps. The first-type preconfigured measurement gaps are preconfigured measurement gaps that are per UE gaps, and the first-type legacy measurement gaps are legacy measurement gaps that are per UE gaps.

In some optional implementations, the number of activated per FR1 gaps is equal to a number of activated second-type preconfigured measurement gaps; or the number of activated per FR1 gaps is equal to a sum of the number of activated second-type preconfigured measurement gaps plus a number of second-type legacy measurement gaps in the multiple measurement gaps. The second-type preconfigured measurement gaps are preconfigured measurement gaps that are per FR1 gaps, and the second-type legacy measurement gaps are legacy measurement gaps that are per FR1 gaps.

In some optional implementations, the number of activated per FR2 gaps is equal to a number of activated third-type preconfigured measurement gaps; or the number of activated per FR2 gaps is equal to a sum of the number of activated third-type preconfigured measurement gaps plus a number of third-type legacy measurement gaps in the multiple measurement gaps. The third-type preconfigured measurement gaps are preconfigured measurement gaps that are per FR2 gaps, and the third-type legacy measurement gaps are legacy measurement gaps that are per FR2 gaps.

In some optional implementations, the receiving unit 301 is further configured to receive first indication information. The first indication information is used for indicating: for each of N bandwidth parts (BWPs), whether the preconfigured measurement gaps are activated when the BWP is activated, N being a positive integer.

In some optional implementations, in a case that a number of the preconfigured measurement gaps is more than one, the first indication information is further used for indicating identifiers of the preconfigured measurement gaps.

In some optional implementations, the apparatus further includes an acquisition unit.

The acquisition unit is configured to acquire first configuration information. The first configuration information is used for configuring an associated measurement configuration corresponding to the preconfigured measurement gaps, and the associated measurement configuration is used for determining a use case associated with the preconfigured measurement gaps.

In some optional implementations, in a case that a number of the preconfigured measurement gaps is more than one, the first configuration information is used for configuring a corresponding associated measurement configuration for each of the preconfigured measurement gaps.

In some optional implementations, the first configuration information is predefined; or the first configuration information is configured by the RRC signaling.

In some optional implementations, in a case that the first configuration information is configured by the RRC signaling, the first configuration information is carried in an RRC signaling for configuring measurement configuration information.

In some optional implementations, all of the multiple measurement gaps are preconfigured measurement gaps. In a case that a BWP is switched: if a measurement object does not change, the associated measurement configuration corresponding to the preconfigured measurement gaps does not change; and if the measurement object changes, the associated measurement configuration corresponding to the preconfigured measurement gaps is determined based on a network configuration.

In some optional implementations, a first portion of the multiple measurement gaps are preconfigured measurement gaps, and a second portion of the multiple measurement gaps are legacy measurement gaps. In a case that a BWP is switched: if a measurement object is not changed, the associated measurement configuration corresponding to the preconfigured measurement gaps and an associated measurement configuration corresponding to the legacy measurement gaps do not change; and if the measurement object changes, the associated measurement configuration corresponding to the preconfigured measurement gaps and/or the associated measurement configuration corresponding to the legacy measurement gaps are/is determined based on a network configuration.

In some optional implementations, the receiving unit 302 is further configured to receive second configuration information. The second configuration information is used for configuring: for each of M bandwidth parts (BWPs), an associated measurement configuration corresponding to the preconfigured measurement gaps when the BWP is activated, M being a positive integer.

In some optional implementations, in a case that a number of the preconfigured measurement gaps is more than one, the second configuration information is used for configuring: for each of M BWPs, an associated measurement configuration corresponding to each of the preconfigured measurement gaps when the BWP is activated, M being a positive integer.

In some optional implementations, the second configuration information is configured by a radio resource control (RRC) signaling or a media access control (MAC) control element (CE).

In some optional implementations, the receiving unit 302 is further configured to receive second configuration information. The second configuration information is used for configuring an associated measurement configuration corresponding to the preconfigured measurement gaps. The second configuration information is carried in a measurement gap configuration corresponding to the preconfigured measurement gaps. The associated measurement configuration corresponding to the preconfigured measurement gaps does not change when a BWP is switched.

In some optional implementations, the second configuration information is carried in a radio resource control (RRC) configuration signaling or an RRC reconfiguration signaling or an RRC reestablishment signaling.

In some optional implementations, the receiving unit 302 is further configured to receive third configuration information. The third configuration information is used for configuring: for each of M bandwidth parts (BWPs), an associated measurement configuration corresponding to the legacy measurement gaps when the BWP is activated, M being a positive integer.

In some optional implementations, in a case that a number of the legacy measurement gaps is more than one, the third configuration information is used for configuring: for each of M BWPs, an associated measurement configuration corresponding to each of the legacy measurement gaps when the BWP is activated, M being a positive integer.

In some optional implementations, the third configuration information is configured by a radio resource control (RRC) signaling or a media access control (MAC) control element (CE).

In some optional implementations, the receiving unit 302 is further configured to receive third configuration information. The third configuration information is used for configuring an associated measurement configuration corresponding to the legacy measurement gaps. The third configuration information is carried in a measurement gap configuration corresponding to the legacy measurement gaps. The associated measurement configuration corresponding to the legacy measurement gaps does not change when a BWP is switched.

In some optional implementations, the third configuration information is carried in a radio resource control (RRC) configuration signaling or an RRC reconfiguration signaling or an RRC reestablishment signaling.

Those skilled in the art should understand that relevant description of the above apparatus for measurement gap enhancement according to the embodiments of the disclosure can be understood with reference to the relevant description of the method for measurement gap enhancement according to the embodiments of the disclosure.

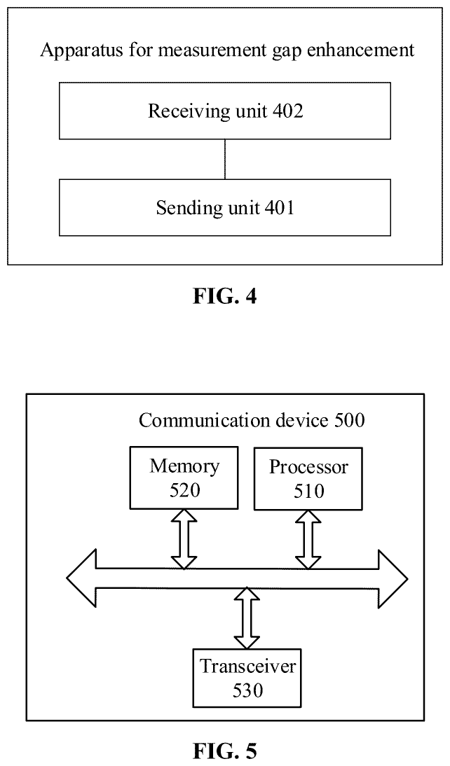

FIG. 4 illustrates a second schematic diagram of structural composition of an apparatus for measurement gap enhancement according to embodiments of the disclosure. As illustrated in FIG. 4, the apparatus for measurement gap enhancement is applied to a network device, and includes a sending unit 401.

The sending unit 401 is configured to send configuration information of concurrent gaps. The concurrent gaps include multiple measurement gaps. At least part of the multiple measurement gaps are preconfigured measurement gaps. The preconfigured measurement gaps are capable of being activated or deactivated.

In some optional implementations, the concurrent gaps satisfy at least one of following: a total number of measurement gaps in the multiple measurement gaps is smaller than or equal to a first number; a number of per UE gaps in the multiple measurement gaps is smaller than or equal to a second number; a number of per FR1 gaps in the multiple measurement gaps is smaller than or equal to a third number; or a number of per FR2 gaps in the multiple measurement gaps is smaller than or equal to a fourth number.

In some optional implementations, the apparatus further includes a receiving unit 402.

The receiving unit 402 is configured to receive first capability information reported by the terminal device. The first capability information is used for indicating at least one of following: a total number of measurement gaps supported by the terminal device is not greater than the first number; a number of per UE gaps supported by the terminal device is not greater than the second number; a number of per FR1 gaps supported by the terminal device is not greater than the third number; or a number of per FR2 gaps supported by the terminal device is not greater than the fourth number.

In some optional implementations, the concurrent gaps satisfy at least one of following: a total number of activated measurement gaps in the multiple measurement gaps is smaller than or equal to a fifth number; a number of activated per UE gaps in the multiple measurement gaps is smaller than or equal to a sixth number; a number of activated per FR1 gaps is smaller than or equal to a seventh number; or a number of activated per FR2 gaps in the multiple measurement gaps is smaller than or equal to an eighth number.

In some optional implementations, the apparatus further includes a receiving unit 402.

The receiving unit 402 is configured to receive second capability information reported by the terminal device. The second capability information is used for indicating at least one of following: a total number of activated measurement gaps supported by the terminal device is not greater than the fifth number; a number of activated per UE gaps supported by the terminal device is not greater than the sixth number; a number of activated per FR1 gaps supported by the terminal device is not greater than the seventh number; or a number of activated per FR2 gaps supported by the terminal device is not greater than the eighth number.

In some optional implementations, the total number of activated measurement gaps is equal to a number of activated preconfigured measurement gaps; or the total number of activated measurement gaps is equal to a sum of the number of activated preconfigured measurement gaps plus a number of legacy measurement gaps in the multiple measurement gaps.

In some optional implementations, the number of activated per UE gaps is equal to a number of activated first-type preconfigured measurement gaps; or the number of activated per UE gaps is equal to a sum of the number of activated first-type preconfigured measurement gaps plus a number of first-type legacy measurement gaps in the multiple measurement gaps. The first-type preconfigured measurement gaps are preconfigured measurement gaps that are per UE gaps, and the first-type legacy measurement gaps are legacy measurement gaps that are per UE gaps.

In some optional implementations, the number of activated per FR1 gaps is equal to a number of activated second-type preconfigured measurement gaps; or the number of activated per FR1 gaps is equal to a sum of the number of activated second-type preconfigured measurement gaps plus a number of second-type legacy measurement gaps in the multiple measurement gaps. The second-type preconfigured measurement gaps are preconfigured measurement gaps that are per FR1 gaps and the second-type legacy measurement gaps are legacy measurement gaps that are per FR1 gaps.

In some optional implementations, the number of activated per FR2 gaps is equal to a number of activated third-type preconfigured measurement gaps; or the number of activated per FR2 gaps is equal to a sum of the number of activated third-type preconfigured measurement gaps plus a number of third-type legacy measurement gaps in the multiple measurement gaps. The third-type preconfigured measurement gaps are preconfigured measurement gaps that are per FR2 gaps, and the third-type legacy measurement gaps are legacy measurement gaps that are per FR2 gaps.

In some optional implementations, the sending unit 401 is further configured to send first indication information. The first indication information is used for indicating: for each of N bandwidth parts (BWPs), whether the preconfigured measurement gaps are activated when the BWP is activated, N being a positive integer.

In some optional implementations, in a case that a number of the preconfigured measurement gaps is more than one, the first indication information is further used for indicating identifiers of the preconfigured measurement gaps.

In some optional implementations, the sending unit 401 is further configured to send first configuration information. The first configuration information is used for configuring an associated measurement configuration corresponding to the preconfigured measurement gaps, and the associated measurement configuration is used for determining a use case associated with the preconfigured measurement gaps.

In some optional implementations, in a case that a number of the preconfigured measurement gaps is more than one, the first configuration information is used for configuring a corresponding associated measurement configuration for each of the preconfigured measurement gaps.

In some optional implementations, the first configuration information is configured by a radio resource control (RRC) signaling.

In some optional implementations, the first configuration information is carried in an RRC signaling for configuring measurement configuration information.

In some optional implementations, all of the multiple measurement gaps are preconfigured measurement gaps. In a case that a BWP is switched: if a measurement object does not change, the associated measurement configuration corresponding to the preconfigured measurement gaps does not change; and if the measurement object changes, the associated measurement configuration corresponding to the preconfigured measurement gaps is determined based on a network configuration.

In some optional implementations, a first portion of the multiple measurement gaps are preconfigured measurement gaps, and a second portion of the multiple measurement gaps are legacy measurement gaps. In a case that a BWP is switched: if a measurement object is not changed, the associated measurement configuration corresponding to the preconfigured measurement gaps and an associated measurement configuration corresponding to the legacy measurement gaps do not change; and if the measurement object changes, the associated measurement configuration corresponding to the preconfigured measurement gaps and/or the associated measurement configuration corresponding to the legacy measurement gaps are/is determined based on a network configuration.

In some optional implementations, the sending unit 401 is further configured to send second configuration information. The second configuration information is used for configuring: for each of M bandwidth parts (BWPs), an associated measurement configuration corresponding to the preconfigured measurement gaps when the BWP is activated, M being a positive integer.

In some optional implementations, in a case that a number of the preconfigured measurement gaps is more than one, the second configuration information is used for configuring: for each of M BWPs, a corresponding associated measurement configuration for each of the preconfigured measurement gaps when the BWP is activated, M being a positive integer.

In some optional implementations, the second configuration information is configured by a radio resource control (RRC) signaling or a media access control (MAC) control element (CE).

In some optional implementations, the sending unit 401 is further configured to send second configuration information. The second configuration information is used for configuring an associated measurement configuration corresponding to the preconfigured measurement gaps. The second configuration information is carried in a measurement gap configuration corresponding to the preconfigured measurement gaps. The associated measurement configuration corresponding to the preconfigured measurement gaps does not change when a BWP is switched.

In some optional implementations, the second configuration information is carried in a radio resource control (RRC) configuration signaling or an RRC reconfiguration signaling or an RRC reestablishment signaling.

In some optional implementations, the sending unit 401 is further configured to send third configuration information. The third configuration information is used for configuring: for each of M bandwidth parts (BWPs), an associated measurement configuration corresponding to the legacy measurement gaps when the BWP is activated, M being a positive integer.

In some optional implementations, in a case that a number of the legacy measurement gaps is more than one, the third configuration information is used for configuring: for each of M BWPs, a corresponding associated measurement configuration for each of the legacy measurement gaps when the BWP is activated, M being a positive integer.

In some optional implementations, the third configuration information is configured by a radio resource control (RRC) signaling or a media access control (MAC) control element (CE).

In some optional implementations, the sending unit 401 is further configured to send third configuration information. The third configuration information is used for configuring an associated measurement configuration corresponding to the legacy measurement gaps. The third configuration information is carried in a measurement gap configuration corresponding to the legacy measurement gaps. The associated measurement configuration corresponding to the legacy measurement gaps does not change when a BWP is switched.

In some optional implementations, the third configuration information is carried in a radio resource control (RRC) configuration signaling or an RRC reconfiguration signaling or an RRC reestablishment signaling.

Those skilled in the art should understand that relevant description of the above apparatus for measurement gap enhancement according to the embodiments of the disclosure can be understood with reference to the relevant description of the method for measurement gap enhancement according to the embodiments of the disclosure.

FIG. 5 illustrates a schematic structural diagram of a communication device 500 according to embodiments of the disclosure. The communication device may be a terminal device, or may be a network device. The communication device 500 as illustrated in FIG. 5 includes a processor 510. The processor 510 may call and run a computer program from a memory to implement the method according to the embodiments of the disclosure.

Optionally, as illustrated in FIG. 5, the communication device 500 may further include a memory 520. The processor 510 may call and run a computer program from the memory 520 to implement the method according to the embodiments of the disclosure.

The memory 520 may be a device independent from the processor 510, or may be integrated in the processor 510.

Optionally, as illustrated in FIG. 5, the communication device 500 may further include a transceiver 530. The processor 510 may control the transceiver 530 to communication with other devices, in particular to send information or data to other devices or receive information or data from other device.

The transceiver 530 may include a transmitter and a receiver. The transceiver 530 may further include an antenna, and there may be one or more antennas.

Optionally, the communication device 500 may particularly be the network device of the embodiments of the disclosure, and the communication device 500 may implement corresponding procedures that are implemented by the network device in various methods according to the embodiments of the disclosure, which is not described here again for simplicity.

Optionally, the communication device 500 may particularly be a mobile terminal/terminal device according to the embodiments of the disclosure, and the communication device 500 may implement corresponding procedures that are implemented by the mobile terminal/terminal device in various methods according to the embodiments of the disclosure, which is not described here again for simplicity.

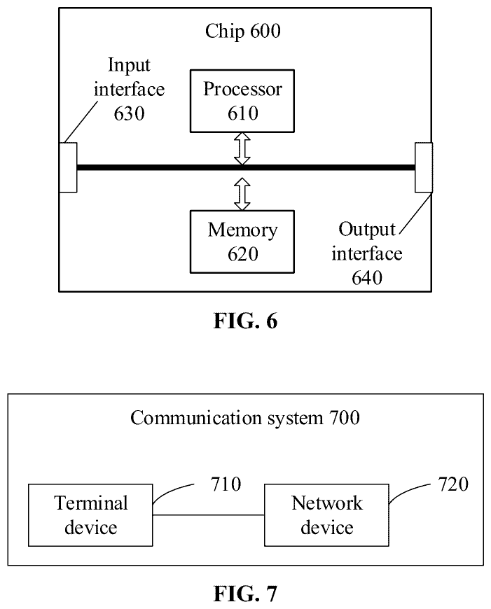

FIG. 6 illustrates a schematic structural diagram of a chip according to embodiments of the disclosure. The chip 600 as illustrated in FIG. 6 includes a processor 610. The processor 610 may call and run a computer program from a memory to implement the method according to the embodiments of the disclosure.

Optionally, as illustrated in FIG. 6, the chip 600 may further include a memory 620. The processor 610 may call and run a computer program from the memory 620 to implement the method according to the embodiments of the disclosure.

The memory 620 may be a device independent from the processor 610, or may be integrated in the processor 610.

Optionally, the chip 600 may further include an input interface 630. The processor 610 may control the input interface 630 to communicate with other devices or chips, in particularly to acquire information or data sent by other devices or chips.

Optionally, the chip 600 may further include an output interface 640. The processor 610 may control the output interface 640 to communicate with other devices or chips, in particularly to output information or data to other devices or chips.

Optionally, the chip may be applied to the network device of the embodiments of the disclosure, and the chip may implement corresponding procedures that are implemented by the network device in various methods according to the embodiments of the disclosure, which is not described here again for simplicity.

Optionally, the chip may be applied to a mobile terminal/terminal device according to the embodiments of the disclosure, and the chip may implement corresponding procedures that are implemented by the mobile terminal/terminal device in various methods according to the embodiments of the disclosure, which is not described here again for simplicity.

It should be understood that, the chip mentioned in the embodiments of the disclosure may also be referred to as a system-level chip, a system chip, a chip system or a system-on-chip.

FIG. 7 illustrates a schematic block diagram of a communication system 700 according to embodiments of the disclosure. As illustrated in FIG. 7, the communication system 700 includes a terminal device 710 and a network device 720.

The terminal device 710 may be applied to implement corresponding functions implemented by a terminal device in the above methods, and the network device 720 may be applied to implement corresponding functions implemented by a network device in the above methods, which is not described here again for simplicity.

It should be understood that the processor of the embodiments of the disclosure may be an integrated circuit chip, and has the capability of signal processing. During implementation, the various steps of in the above method embodiment may be completed by an integrated logic circuit in hardware form or instructions in software form in a processor. The above processor may be a general-purpose processor, a digital signal processor (DSP), an application specific integrated circuit (ASIC), a field programmable gate array (FPGA), or another programmable logical device, a discrete gate or a transistor logical device, or a discrete hardware component. The processor may implement or perform the various methods, steps or logic blocks disclosed in the embodiments of the disclosure. The universal processor may be a microprocessor or the processor may also be any conventional processor and the like. The steps of the methods disclosed in combination with the embodiments of the disclosure may be directly embodied as being performed and completed by a hardware decoding processor, or being performed and completed by a combination of hardware and software modules in a decoding processor. The software module may be located in a mature storage medium in the art such as a random access memory, a flash memory, a read-only memory, a programmable read-only memory, an electrically erasable programmable, or a register. The storage medium is in a memory, and a processor reads information from the memory to implement steps of the above methods in combination with the hardware.

It may be understood that the memory in the embodiments of the disclosure may be a volatile memory or a non-volatile memory, or may include both a volatile memory and a non-volatile memory. The non-volatile memory may be a read-only memory (ROM), a programmable ROM (PROM), an erasable PROM (RPROM), an electrically RPROM (EEPROM), or a flash memory. The volatile memory may be a random access memory (RAM) that is used as an external cache. By way of example, but not limiting description, RAMs in many forms are available, for example, a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a directly Rambus RAM (DR RAM). It should be noted that, the memory in the system and method described herein is intended to include but not limited to memories of these and any other suitable types.

It should be understood that the memories are exemplary but not limiting description. For example, the memory in the embodiments of the disclosure may also be a static RAM (SRAM), a dynamic RAM (DRAM), a synchronous DRAM (SDRAM), a double data rate SDRAM (SSD SDRAM), an enhanced SDRAM (ESDRAM), a synch link DRAM (SLDRAM), or a direct Rambus RAM (DR RAM). That is to say, the memory in the embodiments of the disclosure is intended to include but not limited to memories of these and any other suitable types.

Embodiments of the disclosure further provide a computer-readable storage medium for storing a computer program.

Optionally, the computer-readable storage medium may be applied to the network device of the embodiments of the disclosure, and the computer program enables a computer to implement corresponding procedures that are implemented by the network device in various methods according to the embodiments of the disclosure, which is not described here again for simplicity.

Optionally, the computer-readable storage medium may be applied to a mobile terminal/terminal device according to the embodiments of the disclosure, and the computer program enables a computer to implement corresponding procedures that are implemented by the mobile terminal/terminal device in various methods according to the embodiments of the disclosure, which is not described here again for simplicity.

Embodiments of the disclosure further provide a computer program product including computer program instructions.

Optionally, the computer program product may be applied to the network device of the embodiments of the disclosure, and instructions of the computer program product enable a computer to implement corresponding procedures that are implemented by the network device in various methods according to the embodiments of the disclosure, which is not described here again for simplicity.

Optionally, the computer program product may be applied to a mobile terminal/terminal device according to the embodiments of the disclosure, and instructions of the computer program product enable a computer to implement corresponding procedures that are implemented by the mobile terminal/terminal device in various methods according to the embodiments of the disclosure, which is not described here again for simplicity.

Embodiments of the disclosure further provide a computer program.

Optionally, the computer program may be applied to the network device of the embodiments of the disclosure, and the computer program, when running on a computer, enables the computer to implement corresponding procedures that are implemented by the network device in various methods according to the embodiments of the disclosure, which is not described here again for simplicity.

Optionally, the computer program may be applied to a mobile terminal/terminal device according to the embodiments of the disclosure, and the computer program, when running on a computer, enables the computer to implement corresponding procedures that are implemented by the mobile terminal/terminal device in various methods according to the embodiments of the disclosure, which is not described here again for simplicity.

Those of ordinary skill in the art may realize that the units and algorithm steps of various examples described in combination with the embodiments disclosed herein may be implemented by electronic hardware, or a combination of computer software and electronic hardware. Whether the functions are performed in form of hardware or software form depends on the specific application and design constraint conditions of the technical solution. Professionals may use a different method to realize the described function for each specific application, and such implementation should not be construed as extending beyond the scope of the disclosure

Those skilled in the art may clearly appreciate that for convenience and simplicity of description, the particular operation procedures of the system, apparatus and units described above may refer to corresponding procedures in the foregoing method embodiment, which will not be described herein again.

In some embodiments provided in the disclosure, it is to be understood that the disclosed system, device and method may be implemented in other ways. For example, the device embodiment described above is only exemplary, and for example, division of the units is only division in logic functions, and division may be made in other ways during practical implementation. For example, multiple units or components may be combined or integrated into another system, or some features may be neglected or not executed. In addition, coupling or direct coupling or communication connection between various displayed or discussed components may be indirect coupling or communication connection, implemented through some interfaces, devices or units, and may be electrical and mechanical or in other forms.

The units described as separate components may or may not be physically discrete from one another. Components displayed as units may or may not be physical units, and can be located at the same place or may be distributed to multiple network units. Some or all of the units may be chosen to realize the purpose of the solution of the embodiments according to actual requirements.

Additionally, various functional units in the embodiments of the disclosure may be integrated in one processing unit, or may exist separately physically; or two or more units may be integrated in one unit.

If implemented in form of software functional units and sold or used as independent product, the functions may be stored in a computer-readable storage medium. Based on such understanding, the technical solution of the disclosure substantially or in part making contributions to the related art or a part of the technical solution may be embodied in a software product. The computer software product is stored in a storage medium, and includes several instructions to enable a computer device (which may be a personal computer, a server, a network device or the like) to perform all or some steps of the method according to various embodiments of the disclosure. The foregoing storage medium includes various media capable of storage program codes such as a USB flash drive, a mobile hard disk drive, a read-only memory (ROM), a random access memory (RAM), a magnetic disc, or a compact disc (CD).

Stated above is merely detailed description of the disclosure, but the scope of protection of the disclosure is not limited thereto. Any modification or replacement that is easily conceivable by those familiar with the related art within the technical range disclosed by the disclosure shall fall within the scope of protection of the disclosure. Therefore, the scope of protection of the disclosure should be subjected to the claimed scope of the claims.

1. A method for measurement gap enhancement, comprising:
receiving, by a terminal device, configuration information of concurrent gaps, wherein the concurrent gaps comprise a plurality of measurement gaps, at least part of the plurality of measurement gaps are preconfigured measurement gaps, and the preconfigured measurement gaps are capable of being activated or deactivated.

2. The method of claim 1, wherein the concurrent gaps satisfy at least one of following:
a total number of measurement gaps in the plurality of measurement gaps is smaller than or equal to a first number;
a number of per UE gaps in the plurality of measurement gaps is smaller than or equal to a second number;
a number of per FR1 gaps in the plurality of measurement gaps is smaller than or equal to a third number; or
a number of per FR2 gaps in the plurality of measurement gaps is smaller than or equal to a fourth number.

3. The method of claim 1, wherein the concurrent gaps satisfy at least one of following:
a total number of activated measurement gaps in the plurality of measurement gaps is smaller than or equal to a fifth number;
a number of activated per UE gaps in the plurality of measurement gaps is smaller than or equal to a sixth number;
a number of activated per FR1 gaps is smaller than or equal to a seventh number; or
a number of activated per FR2 gaps in the plurality of measurement gaps is smaller than or equal to an eighth number.

4. The method of claim 3, wherein
the number of activated per UE gaps is equal to a number of activated first-type preconfigured measurement gaps; or
the number of activated per UE gaps is equal to a sum of the number of activated first-type preconfigured measurement gaps plus a number of first-type legacy measurement gaps in the plurality of measurement gaps;
wherein the first-type preconfigured measurement gaps are preconfigured measurement gaps that are per UE gaps, and the first-type legacy measurement gaps are legacy measurement gaps that are per UE gaps;
wherein the number of activated per FR1 gaps is equal to a number of activated second-type preconfigured measurement gaps; or
the number of activated per FR1 gaps is equal to a sum of the number of activated second-type preconfigured measurement gaps plus a number of second-type legacy measurement gaps in the plurality of measurement gaps;
wherein the second-type preconfigured measurement gaps are preconfigured measurement gaps that are per FR1 gaps, and the second-type legacy measurement gaps are legacy measurement gaps that are per FR1 gaps;
wherein the number of activated per FR2 gaps is equal to a number of activated third-type preconfigured measurement gaps; or
the number of activated per FR2 gaps is equal to a sum of the number of activated third-type preconfigured measurement gaps plus a number of third-type legacy measurement gaps in the plurality of measurement gaps;
wherein the third-type preconfigured measurement gaps are preconfigured measurement gaps that are per FR2 gaps, and the third-type legacy measurement gaps are legacy measurement gaps that are per FR2 gaps.

5. The method of claim 1, further comprising:
receiving, by the terminal device, first indication information, wherein the first indication information is used for indicating: for each of N bandwidth parts (BWPs), whether the preconfigured measurement gaps are activated when the BWP is activated, N being a positive integer.

6. The method of claim 1, further comprising:
acquiring, by the terminal device, first configuration information, wherein the first configuration information is used for configuring an associated measurement configuration corresponding to the preconfigured measurement gaps, and the associated measurement configuration is used for determining a use case associated with the preconfigured measurement gaps.

7. The method of claim 6, wherein in a case that a number of the preconfigured measurement gaps is more than one, the first configuration information is used for configuring a corresponding associated measurement configuration for each of the preconfigured measurement gaps.

8. The method of claim 6, wherein in a case that the first configuration information is configured by the RRC signaling, the first configuration information is carried in an RRC signaling for configuring measurement configuration information.

9. The method of claim 6, wherein all of the plurality of measurement gaps are preconfigured measurement gaps; and in a case that a BWP is switched:
when a measurement object does not change, the associated measurement configuration corresponding to the preconfigured measurement gaps does not change; and
when the measurement object changes, the associated measurement configuration corresponding to the preconfigured measurement gaps is determined based on a network configuration.

10. A terminal device, comprising a processor and a memory, wherein the memory is configured to store a computer program, and the processor is configured to call and run the computer program stored in the memory to perform operation of:
receiving configuration information of concurrent gaps, wherein the concurrent gaps comprise a plurality of measurement gaps, at least part of the plurality of measurement gaps are preconfigured measurement gaps, and the preconfigured measurement gaps are capable of being activated or deactivated.

11. The terminal device of claim 10, wherein the concurrent gaps satisfy at least one of following:
a total number of measurement gaps in the plurality of measurement gaps is smaller than or equal to a first number;
a number of per UE gaps in the plurality of measurement gaps is smaller than or equal to a second number;
a number of per FR1 gaps in the plurality of measurement gaps is smaller than or equal to a third number; or
a number of per FR2 gaps in the plurality of measurement gaps is smaller than or equal to a fourth number.

12. The terminal device of claim 10, wherein the processor is further configured to:
receive first indication information, wherein the first indication information is used for indicating: for each of N bandwidth parts (BWPs), whether the preconfigured measurement gaps are activated when the BWP is activated, N being a positive integer.

13. The terminal device of claim 10, wherein the processor is further configured to:
acquire first configuration information, wherein the first configuration information is used for configuring an associated measurement configuration corresponding to the preconfigured measurement gaps, and the associated measurement configuration is used for determining a use case associated with the preconfigured measurement gaps.

14. The terminal device of claim 13, wherein all of the plurality of measurement gaps are preconfigured measurement gaps; and in a case that a BWP is switched:
when a measurement object does not change, the associated measurement configuration corresponding to the preconfigured measurement gaps does not change; and
when the measurement object changes, the associated measurement configuration corresponding to the preconfigured measurement gaps is determined based on a network configuration.

15. The terminal device of claim 14, wherein the processor is further configured to:
receive second configuration information, wherein the second configuration information is used for configuring: for each of M bandwidth parts (BWPs), an associated measurement configuration corresponding to the preconfigured measurement gaps when the BWP is activated, M being a positive integer.

16. The terminal device of claim 14, wherein the processor is further configured to:
receive second configuration information, wherein the second configuration information is used for configuring an associated measurement configuration corresponding to the preconfigured measurement gaps, the second configuration information is carried in a measurement gap configuration corresponding to the preconfigured measurement gaps, and the associated measurement configuration corresponding to the preconfigured measurement gaps does not change when a BWP is switched.

17. The terminal device of claim 15, wherein the processor is further configured to:
receive third configuration information, wherein the third configuration information is used for configuring: for each of M bandwidth parts (BWPs), an associated measurement configuration corresponding to the legacy measurement gaps when the BWP is activated, M being a positive integer.

18. A network device, comprising a processor and a memory, wherein the memory is configured to store a computer program, and the processor is configured to call and run the computer program stored in the memory to perform operation of:
sending configuration information of concurrent gaps, wherein the concurrent gaps comprise a plurality of measurement gaps, at least part of the plurality of measurement gaps are preconfigured measurement gaps, and the preconfigured measurement gaps are capable of being activated or deactivated.

19. The network device of claim 18, wherein the concurrent gaps satisfy at least one of following:
a total number of measurement gaps in the plurality of measurement gaps is smaller than or equal to a first number;
a number of per UE gaps in the plurality of measurement gaps is smaller than or equal to a second number;
a number of per FR1 gaps in the plurality of measurement gaps is smaller than or equal to a third number; or
a number of per FR2 gaps in the plurality of measurement gaps is smaller than or equal to a fourth number.

20. The network device of claim 18, wherein the concurrent gaps satisfy at least one of following:
a total number of activated measurement gaps in the plurality of measurement gaps is smaller than or equal to a fifth number;
a number of activated per UE gaps in the plurality of measurement gaps is smaller than or equal to a sixth number,
a number of activated per FR1 gaps is smaller than or equal to a seventh number, or
a number of activated per FR2 gaps in the plurality of measurement gaps is smaller than or equal to an eighth number.
